(19) United States
(12) Patent Application Publication
(10) Pub. No.: US 2021/0223526 A1
(43) Pub. Date: Jul. 22, 2021

(54) LIGHT-PAD MICROSCOPE FOR HIGH-RESOLUTION 3D FLUORESCENCE IMAGING AND 2D FLUCTUATION SPECTROSCOPY

(71) Applicant: EUROPEAN MOLECULAR BIOLOGY LABORATORY, HEIDELBERG (DE)

(72) Inventors: Michael Knop, Heidelberg (DE); Malte Wachsmuth, Heidelberg (DE); Jeremie Capoulade, Heidelberg (DE)

(21) Appl. No.: 17/137,288

(22) Filed: Dec. 29, 2020

Related U.S. Application Data
(63) Continuation-in-part of application No. 13/371,991, filed on Feb. 13, 2012, now Pat. No. 10,908,403.
(60) Provisional application No. 61/442,616, filed on Feb. 14, 2011.

(51) Int. Cl. G02B 21/00; G01N 21/64

(52) U.S. Cl. CPC G02B 21/0032; G01N 21/6458

(57) ABSTRACT

A microscope is described, having an illumination light path for illuminating a sample or object and a viewing light path for viewing the sample. The microscope comprises an illumination light path focusing arrangement in the illumination light path, which comprises a scanning module for generating a substantially two-dimensional sample or object illumination region extending along an illumination direction of the illumination light path and a direction transverse thereto. The microscope further comprises an illumination region-confining device in the illumination light path for selectively illuminating a portion of the substantially two-dimensional object illumination region, wherein the portion of the substantially two-dimensional object illumination region is confined at least in the illumination direction and/or in the direction transversely thereto.

### CROSS-REFERENCE TO RELATED APPLICATIONS

The present application is a continuation-in-part application of U.S. patent application Ser. No. 13/371,991, filed on 14 Feb. 2012, and claims the benefit under 35 USC 119 of U.S. Provisional Patent Application No. 61/442,616 “Light Pad Microscope for high-resolution 3D fluorescence imaging and 2D fluctuation spectroscopy” filed on Feb. 14, 2011. The entire disclosure of U.S. Provisional Patent Application No. 61/442,616 and U.S. patent application Ser. No. 13/371,991 is hereby incorporated herein by reference in its entirety, for all purposes.

### FIELD OF THE INVENTION

The present disclosure relates to optical microscopes and, in particular, to light microscopes with confined focal volumes and methods adapted for sample concentration fluctuation measurements.

### INTRODUCTION

Diffusion contributes fundamentally to the mobility of soluble molecules and thereby to spatio-temporal aspects of many biological processes, from the regulation of cell division and signal transduction inside cells to hormone regulation during tissue genesis and to morphogen gradients in development. It is a challenge to quantify the diffusive properties of biomolecules inside complex cellular environments. Methods and apparatus that allow a direct analysis of diffusion processes are sparse and tailor-made to individual problems.

Determining the properties and behaviour of biomolecules, in particular of proteins and in particular in their natural environment is a key step in elucidating and analysing their functions and the mechanisms behind cellular and developmental processes. Fluorescence correlation spectroscopy (FCS) [1, 2] is a known method for analysis of molecular mobilities, which provides information about mobile and immobile fractions of labelled molecules, their diffusion properties and concentrations as well as the co-diffusion of the differentially labelled molecules that interact with each other.

Confocal laser scanning microscopes (confocal microscopes) are presently the instruments of choice for live cell imaging with high resolution [3] and for FCS as the confocal laser scanning microscopes enable diffraction limited imaging in combination with ultra sensitive photon counting using avalanche photo diodes (APDs). The FCS measurements using the confocal laser scanning microscopes have been applied to quantify the dynamics of protein complex formation involved in signalling (by EMBL [4] and others [5]), to study the maturation of export-competent mRNPs [6, 7] or to characterize a morphogen gradient [8]. The FCS measurements using the confocal laser scanning microscopes are termed “confocal FCS” in this disclosure. The confocal FCS experiments, however, remain a challenge because of the intrinsic limitation imposed by the sequential modus operandi—one point after the other—of confocal FCS data acquisition along with low total fluorescence photon yield with respect to photon input into a sample or object due to out-of-focus illumination [9]. Usually, the confocal laser scanning microscopes permit only one or a few single-point measurements per cell at specifically selected positions [4, 10, 11]

In other words, the confocal FCS does not provide spatially resolved information sufficient to generate images of cells and other biological samples that would allow to visualize diffusion processes and other FCS-derived protein parameters (such as protein interactions) across entire cells or organisms.

Another disadvantage of known methods and apparatuses is that spatially resolved imaging of diffusion is limited or impossible.

It is known that, in conventional microscopy of three-dimensional extended samples or objects, out-of-focus light can degrade the image acquired by a conventional microscope. As a result, a number of techniques have been developed to enable optical sectioning and reject the out-of-focus light from the image. One of the techniques is termed “selective plane illumination microscopy” (SPIM) and uses a sheet of light to illuminate a sample or object located within a focal plane of a detection lens. The illumination of the sample or object is from the side, at a right angle to the axis of the detection lens. Such a system is described, for example, in U.S. Pat. No. 7,554,725.

It is known that the orthogonal illumination of the sample or object can produce shadow artefacts in the images of the sample or object. International Patent Application No 2010/014244 teaches one way in which to overcome these shadow artefacts by using a light beam and a beam path switcher to produce two alternating lights beams. The two alternating light beams are directed onto the sample located in the focal plane of a detection objective.

### SUMMARY OF THE INVENTION

The present disclosure teaches a microscope having an illumination light path for illuminating a sample or object through an illumination objective lens and a viewing light path for viewing the sample through a detection objective lens. The microscope comprises an illumination light path shaping and focussing arrangement in the illumination light path, the illumination light path shaping and focussing arrangement defining a substantially two-dimensional sample or object illumination region extending along an illumination direction of the illumination light path and a direction transverse thereto. The two dimensional object or sample illumination region can be considered to be a light stripe or light-sheet. The illumination light path focussing arrangement may also be termed light path shaping arrangement as the illumination light is shaped into the two dimensional sample illumination region. The illumination light path shaping and focussing arrangement of the microscope may further include a scanning module arranged in the illumination light path for generating the substantially two-dimensional object or sample illumination region.

In one aspect, the scanning module may comprise a plane mirror rotatable around an axis along a first transverse direction transverse to the illumination direction of the illumination light path. The plane mirror may be a galvanometer-driven plane mirror, a microelectromechanical systems (MEMS) plane mirror, or a Piezo-driven plane mirror. The first transverse direction may be parallel to the viewing direction of the viewing light path.

In another aspect of the invention, the scanning module may comprise a scan lens, which is translatable in a second transverse direction transverse to the illumination direction of the illumination light path. The second transverse direction may be orthogonal to the viewing direction.

In a further aspect of the invention, the scanning module may comprise a one-dimensional lens array extending in the second transverse direction, or a two-dimensional lens array extending in the first transverse direction and the second transverse direction. Furthermore, the one-dimensional lens array and the two-dimensional lens array may be translatable in the second transverse direction.

In yet a further aspect of the invention, the scanning module may comprise a curved mirror, e.g. having the shape of a section of a sphere, a cylinder, an extruded parabola, or an extruded hyperbola, wherein the curved mirror is translatable in the second transverse direction.

In an aspect of the present invention, the microscope may further comprise an additional scanning module for moving the illumination light beam across the object or the sample. This scanning module enables the two-dimensional sample illumination region to be at least one of positioned at or scanned across the sample in the viewing direction. In this way, the object or sample may be imaged in three dimensions. The moving of the illumination light beam may be along the viewing direction.

In one aspect of the invention, the additional scanning module may comprise a plane mirror which is rotatable around the second transverse direction.

In a further aspect of the invention, the additional scanning module may comprise at least one of a scan lens, a one-dimensional lens array, a two-dimensional lens array, or a curved mirror, which is translatable in the first transverse direction.

In another aspect of the present invention, the above-mentioned scanning module and the above-mentioned additional scanning module may form a single scanning module for generating the two-dimensional object or sample illumination region as well as for at least one of positioning the two-dimensional object or sample illumination region at or scanning the two-dimensional object or sample illumination region across the object or sample.

For example, the single scanning module may comprise a plane mirror rotatable in both the first transverse direction and the second transverse direction. Alternatively, the single scanning module may comprise a scan lens translatable along both the first transverse direction and the second transverse direction. Alternatively, the single scanning module may comprise a one-dimensional lens array or a two-dimensional lens array translatable along both the first transverse direction and the second transverse direction. Alternatively, the single scanning module may comprise a curved mirror translatable along both the first transverse direction and the second transverse direction.

The microscope further comprises an illumination region-confining device in the illumination light path for selectively illuminating a portion of the substantially two-dimensional object or sample illumination region, wherein the portion of the substantially two-dimensional object illumination region is confined at least in the illumination direction and/or in the direction transversely thereto. The light stripe is thus limited in at least one of the illumination direction and the direction perpendicular thereto essentially forming a portion of the substantially two-dimensional object illumination region also termed “light pad”. A thickness of the substantially two-dimensional object illumination region and of the light pad is much smaller than the length in the illumination direction and the width in a transverse direction thereto. For example, the length of the portion of the substantially two-dimensional object illumination region in the illumination direction and the width in the transverse direction may be about 6-fold or more of the thickness of the portion of the substantially two-dimensional sample illumination region.

The illumination light path focussing and shaping arrangement may comprise at least one of a cylindrical lens, an anamorphically shaped lens, a one-dimensional or a two-dimensional array of spherical or aspherical lenses. The illumination light path focussing and shaping arrangement may also comprise at least one anamorphically shaped mirror. Furthermore, the illumination light path focussing and shaping arrangement may comprise the scanning module and the additional scanning module.

The illumination region-confining device may comprise at least a first aperture for confining the portion of the substantially two-dimensional object or sample illumination region in the illumination direction. The illumination region-confining device may also comprise at least a second aperture for confining the portion of the substantially two-dimensional object illumination region in a direction transversely to the illumination direction. At least one of the first aperture and the second aperture may be adjustable and may be a circular iris or a rectangular aperture or a slit.

The viewing direction of the viewing light path may be substantially perpendicular to the illumination direction. The substantially two-dimensional object or sample illumination region is then adjusted to be in the focal plane of a detection objective lens. In this aspect, the microscope may be based on a single plane illumination microscope (SPIM) with an illumination region confined at least in the illumination direction.

When the microscope according to the invention comprises the additional scanning module for positioning and scanning the substantially two-dimensional object or sample illumination region, the focal plane of the detection objective lens may be moved according to the position of the two-dimensional object illumination region by adjusting at least one of the position or the focal length of the detection objective lens. Thereby, at any moment, the substantially two-dimensional object illumination region lies in the focal plane of the detection objective lens.

Other viewing directions, i.e. directions not perpendicular to the illumination direction, may be used with the present disclosure.

The detection light path or viewing light path may comprise at least one spatial filter that allows to confine the detection area to the portion of the substantially two-dimensional illumination region.

The observation and detection of the sample may be performed with a detector pixel array such as a CCD or EM-CCD camera, onto which the substantially two-dimensional object illumination and detection region is projected/imaged using the viewing light path.

The present disclosure also teaches a method for observing/detecting a sample. The method comprises illuminating a two-dimensional portion of a sample by scanning and focussing an illumination light beam into a substantially two-dimensional object or sample illumination region extending in an illumination direction of the illumination light beam and a direction transverse thereto, wherein illuminating the two-dimensional portion further comprises confining the substantially two-dimensional object illumination region for selectively illuminating a portion of the substantially two-dimensional object illumination region, wherein the portion of the substantially two-dimensional object illumination region is confined in at least one of the illumination direction and the direction transverse to the illumination direction. The portion of the substantially two-dimensional object illumination region may be termed light-pad.

In one aspect of the method according to the present invention, the scanning of the illumination light beam may comprise reflecting the illumination light beam from a plane mirror, the plane mirror being rotatable around an axis along a first transverse direction transverse to the illumination direction of the illumination light path.

In this aspect, the reflecting of the illumination light beam from the plane mirror may comprise rotating the plane mirror around the axis along the first transverse direction.

In another aspect of the method according to the present invention, the scanning of the illumination light beam may comprise passing the illumination light beam through a scan lens, the scan lens being translatable in a second transverse direction transverse to the illumination direction of the illumination light path.

In this aspect, the passing of the illumination light beam through the scan lens may comprise translating the scan lens in the second transverse direction.

In a further aspect of the present invention, the scanning of the illumination light beam may comprise passing the illumination light beam through a lens array, the lens array being a one-dimensional array and extending in the second transverse direction, or being two-dimensional and extending in both the first transverse direction and second transverse direction, wherein the lens array is translatable in the second transverse direction.

In this aspect, the passing of the illumination light beam through the lens array may comprise translating the lens array in the second transverse direction.

In yet a further aspect of the invention, the scanning of the illumination light beam may comprise reflecting the illumination light beam from a curved mirror, the curved mirror being translatable in the second transverse direction. The curved mirror may have the shape of, for example, a section of a sphere, a cylinder, an extruded parabola, or an extruded hyperbola.

In this aspect, the reflecting of the illumination light beam from the curved mirror may comprise translating the curved mirror in the second transverse direction.

Furthermore, the method may comprise moving at least one of the substantially two-dimensional object or sample illumination region or the portion of the substantially two-dimensional object illumination region through the sample. This may be used for scanning the substantially two-dimensional object or sample illumination region through the sample or for positioning the two-dimensional object illumination region at a desired position in the sample, thus enabling the illumination of a desired portion of the sample. The moving of the substantially two-dimensional object illumination region may be performed in 3D in the sample by at least one of moving the illumination objective lens, moving the illumination light path focussing and shaping arrangement or elements thereof, scanning with a scanning module, moving the illumination region-confining device and changing the collimation of the illumination light path. (This can be done by manipulating the wavefront e.g. with a spatial light modulator (SLM) or with a mirror with a modifiable curvature.)

The recording of the light from the sample on every pixel of the detector pixel array may be integrated over a certain period of time in order to obtain an image of the distribution of e.g. fluorescent molecules in the substantially two-dimensional object illumination and detection region.

The light from the sample on every pixel of the detector pixel array may be recorded for a sequence of short time intervals to which a spatio-temporal correlation analysis can be applied to obtain FCS data for each pixel or for each pixel pair on the detector array.

The method may further comprise measuring a signal fluctuation in the portion of the substantially two-dimensional object illumination region. The fluorescence intensity time trace at each pixel or a region or of the portion of the substantially two-dimensional object illumination region may be subject to a fluctuation analysis. The fluctuation analysis can be at least one of temporal autocorrelation analysis, temporal cross-correlation analysis between the signals from different pixels, temporal cross-correlation analysis between the signals from different spectral channels, photon counting histogram, photon coincidence analysis between the signals from different pixels, photon coincidence analysis between the signals from different spectral channels, and other methods known to people skilled in the art.

### SHORT DESCRIPTION OF THE FIGURES

Further aspects and details of the invention will become evident when reading the detailed description with reference to the attached figures, wherein:

FIG. 1A shows a light-sheet based FCS imaging arrangement with a diffraction limited light-pad; FIGS. 1B to 1F show various results of the imaging arrangement.

FIG. 2 shows the microscope of FIG. 1A in more detail;

FIGS. 3A to 3C illustrate the optical light-pad;

FIGS. 4A to 4J illustrate the optical properties of the light-pad microscope;

FIGS. 5A to 5F show 1D—FCS measurements in solution;

FIGS. 6A to 6C show the impact of cell medium on focussing the light sheet;

FIG. 7A to 7G show results of FCS imaging of protein concentration and mobility inside a MDCK cell and a wing imaginal disk from a Drosophila larva recorded with the light pad microscope;

FIGS. 8A to 8F show in vivo confocal FCS measurement for comparison;

FIGS. 9A and 9B show 1D-FCS measurements on Wing imaginal disk from Drosophila larva and 3T3 cells; and

FIGS. 10A to 10E show spatially resolved analysis of HP1α mobility in 3T3 cells by FCS imaging.

FIGS. 11A to 11D show a portion of the illumination unit with a scanning module arranged in the illumination light path.

FIGS. 12A and 12B show a portion of the illumination light unit with an additional scanning module arranged in the illumination light path.

### DETAILED DESCRIPTION

The invention will now be described with reference to the drawings. It will be understood that the examples, embodiments and aspects of the invention described herein are only examples and do not limit the protective scope of the claims in any way. The invention is defined by the claims and their equivalents. It will be understood that features of one aspect or embodiment of the invention can be combined with a feature of a different aspect or aspects and/or embodiments of the invention and that not all features of the examples and embodiment are necessary to implement the invention.

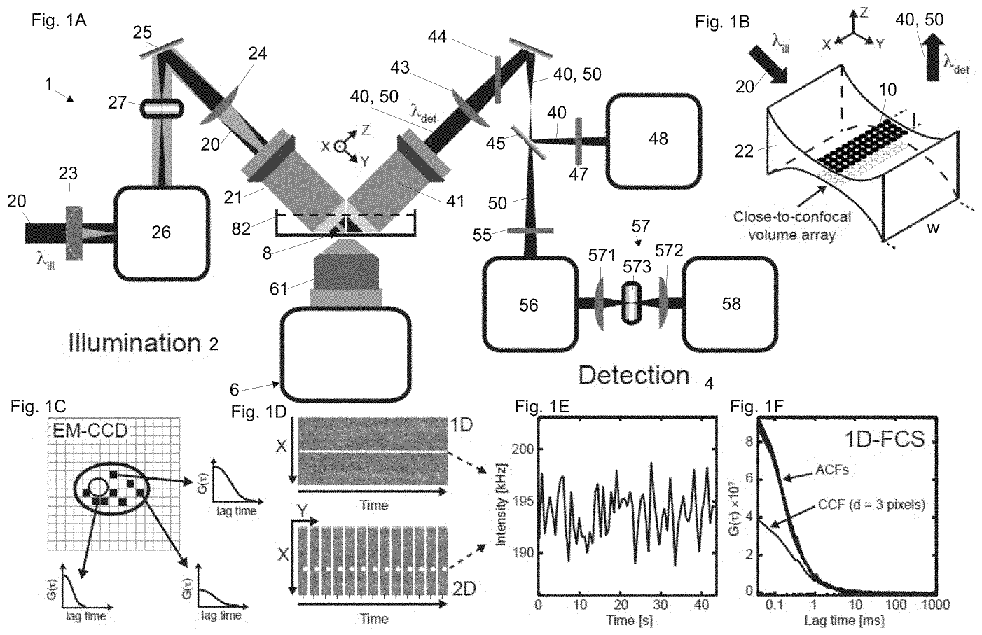

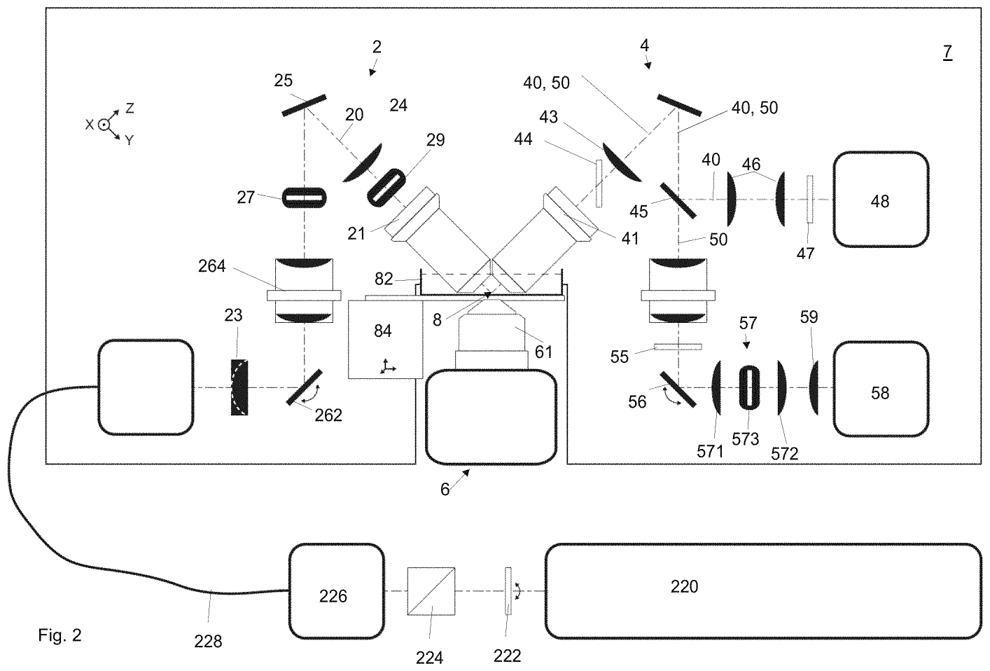

The disclosure teaches a novel microscope termed light-pad microscope 1. The light-pad microscope 1 comprises three modules as shown for example in FIGS. 1A and 1n more detail in FIG. 2: (i) an illumination unit 2 that generates a diffraction-limited two-dimensional object or sample illumination region or light-sheet 22 from an illumination light beam 20; the diffraction-limited light-sheet 22 is confined in at least one direction, thus defining the light-pad 10; (ii) a detection unit 4 that allows the observation along at least one detection light path 40,50 of the focal area of the light-sheet 22 and/or of the light-pad 10; and optionally (iii) an inverted microscope 6 that allows convenient positioning of specific areas of the object or sample 8 into the focus of the light pad 10.

The light-pad microscope 1 of the disclosure provides full spatial control over the excitation of fluorescence as only a cross-section of the object or sample 8 is illuminated by the light sheet 22 and unnecessary out-of-focus exposure is avoided. Concomitantly all emitted photons originate from the focal plane of light-sheet 22 and no filtering of photons based on their spatial origin is needed.

The light-pad microscope 1 is based on two orthogonally arranged objective lenses, an illumination objective lens 21 and a detection objective lens 41. The illumination objective lens 21 and the detection objective lens 41 can be long working distance objective lenses, such as, but not limited to 40×/0.8 NA objectives. It will be appreciated that other objectives with different magnifications and/or numerical apertures can be used. The illumination objective lens 21 and the detection objective lens 41 can be identical or can be different objective lenses with different magnification and/or different numerical aperture. The illumination objective lens 21 and the detection objective lens 41 can be dipped into a Petri dish 82 containing the object or sample 8.

The light-pad microscope 1 can be used with any wavelength or any combination of wavelength considered useful in imaging or FCS and may depend on the sample 8 and the dyes used to investigate the sample 8. For detection of GFP fluorescence, for example, the 488 nm line of an Argon laser 220 (shown in FIG. 2, for example Innova Sabre SBRC-R-DBW/20 from Coherent) with an output power of for example 2 W can be used. The power of the illumination beam 20 can be adjusted for example by passing the illumination beam 20 through a half-wave plate 222 (for example WPMH05M-488, Thorlabs) placed in front of a polarizer 224 (for example a Glan-Taylor polarizer, such as a GL5-A, Thorlabs) followed by an acousto-optical tunable filter 226 (for example AOTF; AA.AOTFnC-400.650-TN, AA Opto-Electronic). A single-mode optical fiber 228 (for example kineFLEX-P-3-S-458-640-2.0-2.0-PL, Point Source) can be used to deliver the light to the setup contained on a breadboard 7. In another implementation, the laser light can be delivered directly to the setup by using optical elements such as mirrors (not shown).

To shape the illumination light beam 20 for the generation of the light-sheet 22 with an illumination light beam shaping and focussing arrangement 260 (see FIGS. 1A, 2, 11, and 12), the illumination light beam 20 can be first collimated and expanded anamorphically so that in an x-direction an approximately constant section is cut out of the Gaussian profile. In the z-direction, the illumination light beam 20 is focused with a cylindrical lens 23 placed in the illumination light path shaping and focussing arrangement 260 (for example with f=75.6 mm). A tube lens 24 (for example with f=245.60 mm) and a water dipping illumination objective lens 21 (for example, Plan-Apochromat 40×/0.8 NA, Leica) with a long exemplary working distance of 3.3 mm may be used to project the focussed illumination light beam 20 to generate the light-sheet 22 in the sample 8.

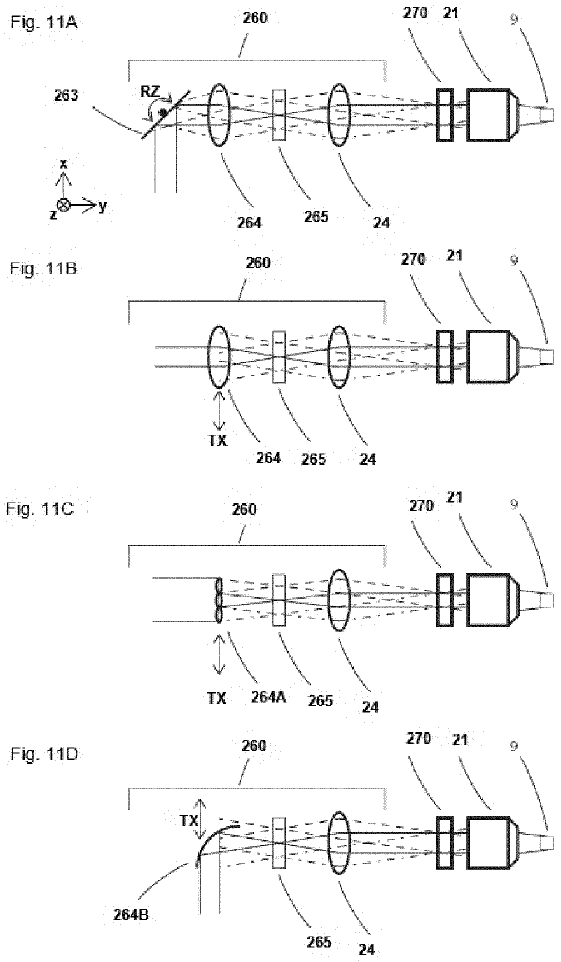

In other aspects of the invention, shown in FIG. 11, the two-dimensional object illumination region is generated by a scanning module comprised in the illumination light path shaping and focussing arrangement 260. The scanning module scans or sweeps the illumination light beam 20 in the x-direction (for which reason the scanning module may also be termed x-scanning module). The scanned illumination light beam 20 may enter further elements of the illumination light path shaping and focussing arrangement 260 and generates an intermediate image 265 in the illumination light beam shaping and focussing arrangement 260. The intermediate image 265 extends in the x-direction due to the scanning movement of the x-scanning module, and in the y-direction, along the illumination light beam 20, before and behind an intermediate focal point of the illumination light-path shaping and focussing arrangement 260. After formation of the intermediate image 265, the illumination light beam 20 is projected by the illumination light beam shaping and focussing arrangement 260 through the illumination region-confining device 270 (see FIGS. 1A, 2, 11A to 11D, 12A and 12B) onto the illumination objective lens 21 and further onto the sample or object 8.

Specifically, in the aspect shown in FIG. 11A, the x-scanning module comprises a plane scanning mirror 263 rotatable around an axis parallel to the z-direction (as indicated by arrow RZ) and a rotation means (not shown) for rotating the plane scanning mirror 263. The rotation means (not shown) may be galvanometer-driven, a Piezo-driven, or a MEMS-driven (Microelectromechanical Systems-driven). The plane scanning mirror 263 reflects towards a scan lens 264 the illumination light beam 20 impinging thereon.

A reciprocating rotation of the plane scanning mirror 263 causes the illumination light beam 20 to impinge on the scan lens 264, the tube lens 24, and the illumination objective lens 21 in a reciprocating fashion around the center of the said lenses 264, 24, and 21 in the x-direction, thereby causing the focus of the illumination light beam 20, at the location of both the intermediate image 265 and in the light-pad 10, to reciprocate in the x-direction. Thereby, the intermediate image 265 and the light-pad 10, both extending in the x-direction and y-direction, are generated.

In the aspect shown in FIG. 11B, the x-scanning module comprises the scan lens 264 and a translation means (not shown) for translating the scan lens 264 in the x-direction (as indicated by arrow TX). The translation means may be a motorized translation stage (not shown).

Translating the scan lens 264 in a reciprocating fashion in the x-direction causes the illumination light beam 20 to impinge on the scan lens 264, the tube lens 24, and the illumination objective lens 21 in a reciprocating fashion in the x-direction around the center of said lenses 264, 24, and 21, thereby causing the focus of the illumination light beam 20, at a location of both the intermediate image 265 and the light-pad 10, to reciprocate in the x-direction. Thereby, the intermediate image 265 and the light-pad 10, both extending in the x-direction and y-direction, are generated.

In the aspect shown in FIG. 11C, the x-scanning module comprises a lens array and a translation means (not shown) for translating the lens array 264A in the x-direction (as indicated by arrow TX). The translation means may be a motorized translation stage (not shown). The lens array 264A may form a one-dimensional array of lenses extending in the x-direction or a two-dimensional array of lenses extending in the x-direction and the z-direction.

Translating the lens array 264A in a reciprocating fashion in the x-direction causes the illumination light beam 20 to impinge on the lens array 264A, the tube lens 24, and the illumination objective lens 21 in a reciprocating fashion in the x-direction around the center of said lens array 264A and said lenses 24 and 21, thereby causing the focus of the illumination light beam 20, at the location of both the intermediate image 265 and the light-pad 10, to reciprocate in the x-direction. Thereby, the intermediate image 265 and the light-pad 10, both extending in the x-direction and y-direction, are generated.

In the aspect shown in FIG. 11D, the x-scanning module comprises a curved mirror 264B and a means for translating the curved mirror 264B in the x-direction (as indicated by arrow TX). The curved mirror 23C may have the shape of, for example, a section of a sphere, a section of a cylinder, a rotated or an extruded parabola, or a rotated or an extruded hyperbola.

Translating the curved mirror 264B in a reciprocating fashion in the x-direction causes the illumination light beam 20 to be reflected from the curved mirror 264B in a reciprocating manner in the x-direction and to further impinge on the tube lens 24 and the illumination objective lens 21 in a reciprocating fashion in the x-direction around the center of said lenses 24 and 21, thereby causing the focus of the illumination light beam 20, at the location of both the intermediate image 265 and the light-pad 10, to reciprocate in the x-direction. Thereby, the intermediate image 265 and the light-pad 10, both extending in the x-direction and y-direction, are generated.

In a further aspect of the invention, at least one of a positioning or scanning of the light-pad 10 in the sample or object 8 in the x-direction is conceivable. To this end, in the x-direction, a center of a range of scanning of the plane scanning mirror 263, the scan lens 264, the lens array 264A, or the curved mirror 264B may be settable. The center of the range of scanning together with a scanning amplitude determines, where in the sample or object 8 the light-pad 10 is generated.

For a precise positioning of the light-sheet 22 in the sample 8 in the z-direction, and/or for scanning the light-sheet 22 through the sample in the z-direction, the illumination light beam 20 may, in another aspect of the invention, further pass through an additional scanning module 26 (which may also be termed z-scanning module 26) of the illumination light path shaping and focussing arrangement 260 (see FIGS. 1A, 11A to 11D, 12A and 12B). The additional scanning module 26 moves the illumination light beam 20 across the sample or object 8 and thus enables at least one of position positing the two-dimensional object illumination region illumination at or the scanning the two-dimensional object illumination region across the sample and or object 8. The moving of the illumination light beam 20 across the sample or object 8 takes place along the viewing direction or along the optical axis of the detection objective lens 41.

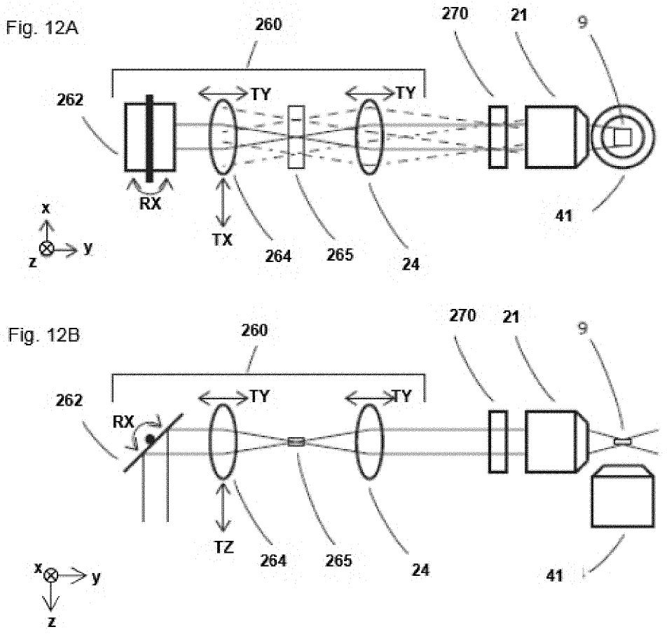

As shown in FIGS. 2, 12A and 12B, the additional scanning module 26 may comprise, for example, a galvanometer-driven plane scanning mirror 262 (VM-500+, GSI) rotatable around an axis parallel to the x-direction (as indicated by arrow RX). In another aspect, the plane scanning mirror 262 may be Piezo-driven or a MEMS-based mirror (microelectromechanical systems). The additional scanning module may further comprise a rotation means (not shown) for rotating the plane scanning mirror 262. The rotation means may be galvanometer-driven, Piezo-driven, or MEMS-driven.

The plane scanning mirror 262 reflects the illumination light beam 20 impinging thereon towards at least one of the scan lens 264, the lens array 264A, or the tube lens 24. A rotation of the plane scanning mirror 262 causes the illumination light beam 20 to impinge on the scan lens 264 or the lens array 264A, on the tube lens 24, and on the illumination objective lens 21 at a correspondingly shifted point on a line though the center of the said lenses 264, 264A, 24, and 21 in the z-direction, thereby causing the focus of the illumination light beam 20, in both the intermediate image 265 and the light-pad 10, to correspondingly shift in the z-direction (see FIGS. 12A and 12B). Thereby, a different portion of the sample or object 8 along the z-direction is illuminated by the light-pad 10.

A reciprocating rotation of the plane scanning mirror 262 likewise causes the light-pad 10 to reciprocate in the z-direction through the sample or object 8. Thereby, the sample or object 8 is scanned.

As also shown in FIGS. 12 A and 12B, the additional or z-scanning module 26 with the plane scanning mirror 262 may be combined with the aspect of the invention as shown in FIG. 11B, i.e. the additional or z-scanning module 26 comprising the mirror 262 may be combined with the x-scanning module comprising the scan lens 264. However, the microscope according to the invention may also comprise the additional or z-scanning module 26 without the x-scanning module 26.

Likewise, the additional or z-scanning module 26 may be combined with the aspects of the invention as shown in FIGS. 11A, 11C, and 11D.

It is furthermore conceivable that the plane scanning mirror 263, in addition to being rotatable around an axis parallel to the z-direction, is rotatable around a further axis parallel to the x-direction by means of a further galvanometer drive, a MEMS drive, or a Piezo drive.

It is moreover conceivable that the scan lens 264 of the aspects as shown in FIGS. 11A and 11B is comprised in the additional or z-scanning module 26. In other words, it is conceivable that the scan lens 264 of the FIG. 11A or 11B is further translatable in the z-direction (as indicated by the arrow TZ in FIG. 12B) by means of a further translationsmeans (not shown), e.g. a motorized translation stage.

It is likewise conceivable that the lens array 264A of the aspect as shown in FIG. 11C is comprised in the additional or z-scanning module 26 and thus is further translatable in the z-direction by means of a further translations means (not shown), e.g. a motorized translation stage.

It is likewise conceivable that the curved mirror 264B of the aspect as shown in FIG. 11D is comprised in the additional or z-scanning module 26 and thus is further translatable in the z-direction by means of a further translation means (not shown), e.g. a motorized translation stage.

Furthermore, in another aspect of the invention, a positioning and/or scanning of the light-pad 10 in the sample or object 8 in the y-direction, i.e. along the illumination light path, is conceivable (as indicated by the arrow TY in FIGS. 12A and 12B). To this end, the scan lens 264 of the aspect shown in FIGS. 11A and 11B, the lens array 264A of the aspect shown in FIG. 11C, or the curved mirror 264B of the aspect shown in FIG. 11D may be translatable in the y-direction by means of a translation means (not shown), e.g. a motorized translation stage. Alternatively, the tube lens 24 may be translatable in the y-direction by means of a translation means (not shown), e.g. a translation stage.

The z-scanning module 262 is arranged at the back focal plane of an F-theta scan lens 264 (S4LFT0061, f=60 mm, Sill Optics). The tube lens 24 (for example with f=245.60 mm) and the illumination objective lens 21 (for example, Plan-Apochromat 40×/0.8 NA, Leica) with a long exemplary working distance of 3.3 mm may be used to generate the light-sheet 22 in the sample 8. The illumination objective lens 21 may be a water dipping illumination objective lens 21.

The width of the light-sheet 22 can be adjusted, for example, between about 20 and 200 μm by modifying, for example, the size of a width confining slit or a width confining iris 27, comprised in the illumination region-confining device 270, and placed in the back focal plane of the tube lens 24 (see FIG. 1A). This allows the illumination of only a part of the sample and thus prevents photobleaching of neighbouring regions during the measurement or image acquisition. The width confining slit 27 may alternatively be placed between the tube lens 24 and the illumination objective lens 21.

A deflection mirror 25 between the scan lens 264 and the tube lens 24 deflects the beam by 45° so that the illumination objective lens 21 points under 45° to a horizontal plane (bottom of the Petri dish) containing the object or sample 8.

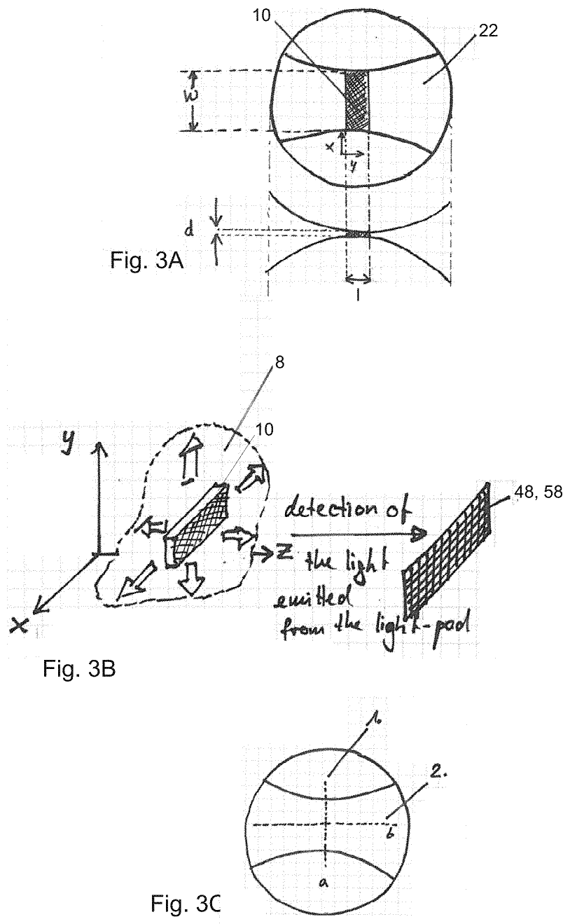

A multiple slit arrangement 27, 29 in the illumination light beam 20 is used to confine the light-sheet 22 to the light-pad 10 by the illumination region-confining device 270. The illumination region-confining device 270 may comprise the width confining slit or iris 27 for confining the width w of the light-sheet 22. The illumination region-confining device 270 may further comprise a length confining slit or iris 29 arranged for example between the tube lens 24 and the illumination objective lens 21 for confining the length 1 of the illumination region or light-sheet 22 in the illumination direction of the illumination light beam 20. Thus the light-sheet 22 can be confined to length 1 and width w forming the light-pad 10 (of width w and length 1) as illustrated in FIGS. 1B and 3A. The upper image of FIG. 3A shows the view on the light-pad 10 through a detection objective lens 41 along the z-direction of FIGS. 1A, 1B and 2. The lower image of FIG. 3A shows the light-sheet 22 and the light-pad 10 seen along the x-direction of FIGS. 1A, 1B and 2, showing the thickness d of the light-sheet 22 and the light-pad 10. Adjustments of the additional scanning module 26 and positions of length confining slit 29 and of the width confining slit 27 provide for further convenient positioning of the light-pad 10 inside a selected region of the object or sample 8 (FIG. 1A-1B and FIGS. 3A to 3C).

It is likewise conceivable that the multiple slit arrangement 27, 29, which is positioned along the illumination light path of the illumination light beam 20 and part of the illumination region-confining device 270, comprises both the width confining slit or iris 27 for confining the width w of the light-sheet 22, and the length confining slit or iris 29 for confining the length 1 of the light-sheet 22 in a one-piece optical element. The one-piece optical element may for instance be, but is not limited to, a rectangular slit or a single iris.

The width confining slit or the iris 27 and the length confining slit or iris 29, when being provided in a one-piece optical element may be arranged at a single position along the illumination light beam 20, for instance between the tube lens 24 and the illumination objective lens 21. FIGS. 11A-D and 12 A-B show the illumination region-confining device 270 positioned between the tube lens 24 and the illumination objective lens 21.

Alternatively, the width confining slit 27 and the length confining slit 29 of the illumination region-confining device 270 may be arranged between the tube lens 24 and the illumination objective lens 21 as separate optical elements.

By arranging the width confining slit 27 and the length confining slit 29 between the tube lens 24 and the illumination objective lens 21, the width confining slit or iris 27 and the length confining slit or iris 29 may be arranged outside both the back focal plane of the tube lens (or a plane conjugate thereto), and also the back focal plane of the illumination objective lens (or a plane conjugate thereto).

The illumination light beam 20 is composed of substantially parallel bundles of rays between the tube lens 24 and the illumination objective lens 21. The arrangement of the width confining slit or iris 27 and the length confining slit or iris 29 between the tube lens 24 and the illumination objective lens 21 enables flexible positioning of the width confining slit or iris 27 and/or the length confining slit or iris 29. The arrangement of the width confining slit or iris 27 and the length confining slit or iris 29 between the tube lens 24 and the illumination objective lens 21 further enables easier adjusting, replacing, and/or repairing of the width confining slit or iris 27 and/or the length confining slit or iris 29. The arrangement of the width confining slit or iris 27 and the length confining slit or iris 29 between the tube lens 24 and the illumination objective lens 21 furthermore minimizes optical aberrations.

For the collection of the emitted fluorescence, a detection objective lens 41, the observation lens, is arranged in an angle of substantially 90° (FIG. 2) to the illumination objective lens 21. In order to avoid reflected laser light, a dichroic mirror 44 (for example a BS HC R488, AHF Analysentechnik if excitation at 488 nm is used) may be placed in front of the detection tube lens 43 that follows the observation lens 41. A flip-mirror 45 may be used to flip the fluorescence light between two alternative detection paths, a first detection light path 40 and a second detection light path 50. Between the sample 8 and the flip-mirror 45, the first detection light path 40 and the second detection light path 50 are superimposed and use the same elements. The present disclosure can be used with both the first detection light path 40 and the second detection light path 50 or only the first detection light path 40 or only the second detection light path 50 can be implemented. If only one light path is used, the flip-mirror 45 can be omitted.

The first detection light path 40 can be used for intensity light-sheet imaging and may comprise a band-pass filter 47 (for example a BrightLine HC 525/45, AHF Analysentechnik) and a Keplerian telescope 46, which may affect the total magnification. The fluorescence signal is focused along the first detection light path 40 onto an electron-multiplying charge-coupled device (EM-CCD) camera 48 (for example a QuantEM:512SC, Photometrics), referred to as imaging camera 48. The pixel size of this imaging camera 48 may be in the sample plane 131×131 nm² (actual size on the chip: 16×16 μm²) and the field of view corresponds to an area of 67×67 μm² in the sample. Smaller or larger pixel sizes and chips and different geometries of the chip can be used.

For light-pad microscopy 1 using the imaging camera 48 and first detection light path 40, shown FIG. 1A and FIG. 2, the sample 8 may further be positioned in 3D using a motorized stage 84 holding the sample 8. Image stacks can be acquired at equidistant sample positions along the optical axis of detection (z-axis) for the case of roundish objects (such as beads or yeast cells). For the case of laterally extended objects used as sample 8, such as Drosophila larva wing imaginal disks, stacks of images can be acquired horizontally (in y-z direction). Larger effective fields of views can be achieved by tiled imaging of neighbouring regions.

The second detection light path 50 may be used for FCS imaging (1D-/2D-FCS recordings) and/or intensity imaging. The second detection light path 50 can contain a band-pass filter 55 (for example BrightLine HC 525/45, AHF Analysentechnik) and a detection scanning module 56. Spatial filtering is achieved by a spatial filter 57 that may comprise two lenses, for example achromatic doublets, a first lens 571 and a second lens 572 (for example f=60 mm, Thorlabs) and an adjustable slit 573 (for example 07 SLT 701, Melles-Griot) placed in the image plane of the first doublet 571. The adjustable slit 573 may also allow for confinement of the light pad 10 arranged perpendicular thereto. The detection scanning module 56 enables positioning of the region for the FCS imaging within the illuminated area of the sample 8, whereas the spatial filter 57 allows the adjustment of the size of the image of this illuminated area. In other words, a section or a portion of the light pad 10 can be selected for imaging or detection along the second detection light path 50. Together with lateral confinement of the light-sheet 22 by the spatial filter 27 (iris) in the illumination light path 20, this defines the light-pad 10 (FIG. 1B and FIG. 3A). Finally, a focussing lens 59, for example an aspherical lens (f=40 mm, Thorlabs), focuses the fluorescent light onto a second EM-CCD camera (for example SamBa SE-34, Sensovation), referred to as FCS camera 58. The total magnification of the second detection light path 50 may be, for example 39×, which may lead to a pixel size of 190×190 nm2 in sample space (actual size on the chip: 7.4×7.4 μm2), and to a maximum field of view that corresponds to 124×94 μm2 in the sample. Other magnifications and other pixel sizes and different detector arrays may be used with the present disclosure and may be adapted to the microscope and the sample 8 to be investigated.

For one-dimension (1D)-FCS data acquisition, the optical path 50 leading to the FCS camera 58 can be used (FIG. 1A and FIG. 2). In order to increase the time resolution, the EM-CCD of the FCS camera 58 may be, if desired, operated in line-scan mode. Instead of transferring a complete frame from the sensor area to the storage area of the chip between subsequent exposure intervals, only a single line is shifted. Then, a fraction of a line or a complete line is transferred through the A/D conversion and amplification chain of the chip and to the frame grabber card PCI-1422 (National Instruments). The readout process is the time-limiting step of CCD image acquisition and this procedure increases significantly the time resolution, e.g. leading to, for example 40 μs (or 25,000 lines per second) for a fraction of 120 pixels of a line. For in vivo measurements, for example 340 pixels (half a line) with a time resolution of 70 μs can be acquired in order to extend the field of view. To increase the number of photoelectrons per data point, the spatial filter 57 in the second detection light path 50 can be arranged such that several lines are illuminated.

The fluorescence signal may be acquired, for example, for 30-60 s for each measurement. The laser may be switched off before and/or during measuring (for example for 5 s) in order to assess the overall background of the measurement.

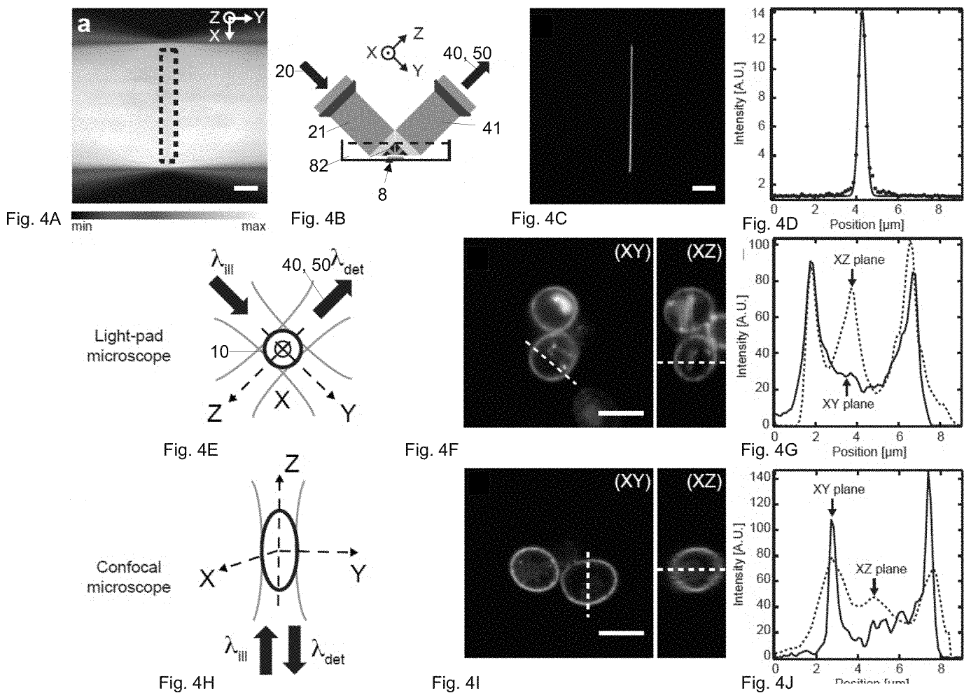

Two-dimensional (2D)-FCS measurements can be performed following the same procedure as for 1D-FCS. The spatial filter 57 may be adjusted in order to illuminate, for example, 20 lines of the EM-CCD chip of FCS camera 58. The corresponding 20 lines are then transferred, for example, to a storage area between subsequent exposure intervals and then converted, amplified and transferred to a frame grabber as a single frame. Here, a time resolution of for example 700 μs can be achieved with present technology when using a frame size of 20 lines of 340 pixels. As for 1D-FCS, for example 5 s at the beginning of or during each measurement can be used used to determine the overall background of the signal. Time series of images or 2D-kymographs are shown in FIGS. 1D, 4F).

An imaging light path 40 with an imaging camera 48 and a separate FCS light path with an FCS camera 58 is described in the above examples with reference to FIGS. 1A and 2. It is also possible to use a combined imaging and FCS light path with a single camera or imaging device used for both the combined imaging and FCS light path. The flip mirror 45 may be omitted.

The laser power used for the FCS imaging can be measured at the focal plane of the illumination lens using for example a Nova II power meter equipped with a PD300 detector (Ophir Optronics, Jerusalem, Israel). In a typical example of a 1D-/2D-FCS in vivo experiment, the laser intensity in focus of the light sheet 22 may be in the range of a few kW·cm⁻². This corresponds to the lower limit of the focal intensity typically used in a conventional confocal FCS setup. Thus, the intensity used in a confocal setup to conduct one FCS measurement allowed the conduction of for example 20 measurements (along the 20 pixels). Thus, and in addition to the avoidance of out-of-focus illumination, the light-pad microscope 1 provides for this example an at least about 20-fold increased efficiency as compared to a usual confocal FCS setup.

In addition, an axial scanning of the illumination objective lens 21 and synchronized scanning of the detection area by synchronized scanning of the detection scanning module 56 or of the detection spatial filter/slit 573 allows to scan the light-pad 10 within the field-of-view of the detection objective lens 41. Alternatively, the cylindrical lens 23 can be scanned to achieve the same effect. Alternatively, a controlled collimation/decollimation of the beam for example by replacing the deflection mirror 25 with a spatial light modulator, for example a mirror with adjustable curvature, can be applied to achieve the same axial scanning of the light-pad 10.

Each pixel of the FCS camera 58 collects the light emitted from a corresponding observation volume element in the light-pad 10 (FIG. 1B). Individual ones of fluorescent molecules such as GFP-tagged proteins generate spatio-temporal concentration (and fluorescence) fluctuations when the fluorescent molecules move within the light-pad 10 e.g. driven by diffusion, thereby crossing individual volume elements. With the use of an EM-CCD chip as FCS camera 58, these fluctuations can be recorded with high time resolution and single-photon sensitivity. Temporal correlation analysis of the intensity time trace at each pixel (FIG. 1C) provides statistical information about frequency and speed of inbound and outbound movements of the fluorescent molecules for each individual one of the volume elements (FIGS. 1D-1F). Upon calibration, this information is translated into spatially resolved maps for example of protein concentrations and protein mobilities, such as diffusion coefficients in the case of soluble molecules.

The optical properties of the light-pad microscope 1 are such that the light-pad microscope 1 generates a diffraction-limited light-pad of a length of approx. 4 μm along the illumination axis providing an array of close-to-confocal individual volumes (see FIG. 1B, FIGS. 3A to 3C and FIG. 4). The width of the light-pad 10 is adjustable by the slit 27 in the illumination light path 20. The pixels of the FCS camera 58 subdivide the maximum usable light-pad area of 3.8×65 μm² (FIG. 4A) into 20 lines of 340 pixels. The observation volume amounts to ˜0.31 fL and corresponds to an almost isotropic point spread function (PSF) (FIG. 4E-4G). The dimensions of the observation volume are determined by the thickness of the light-sheet 22, which may be about 0.7 μm (1/e² along the z axis) or less and by the lateral resolution of the detection objective 41. This yields an observation volume that is for example about 1.6-fold larger than the one of a standard confocal microscope (FIG. 4H-4J).

The light-pad microscope 1 may be built on a vertically erected breadboard 7, as shown in FIG. 1A and FIG. 2. This vertical configuration of the setup has the additional advantage that the vertical configuration enables the use of conventional Petri dishes 82 (without the need of 3D cell culturing or embedding samples in gel, e.g. agarose) with, for example, 60 mm diameter filled with a medium into which the two objective lenses are dipped directly (FIG. 1B, FIG. 2). The vertical configuration also avoids optical aberrations due to refractive index changes at air-glass, glass-medium or medium-agarose interfaces that can be encountered using a conventional light-sheet microscopy configuration with a dry objective lens for illumination. To allow free movement of the sample 8, the Petri dish 82 may be fixed on a three-axis motorized stage 84 (for example: stepper motors: LN-Mini23 manipulator block XY and LN-Mini Z vario, Cell Biology Trading/Luigs & Neumann that enables positioning of the sample 8 with an accuracy of, 50 nm)

The light-pad microscope 1 can be designed such that the sample 8 can be observed from underneath (for example through the glass bottom of the Petri dish, if used) with the help of an optional conventional inverted microscope 6 (for example a Olympus IX 70) equipped with an objective lens 61. For example, a long working distance dry objective lens may be used such as a 20×/0.4 NA lens. A person skilled in the art will choose the best lens for the needs of the application. Due to its larger field of view, the inverted microscope 6 allows easier and faster positioning of larger ones of the biological object or sample 8 in the light-pad or fast selection of cultured cells appropriate for the FCS imaging. For their observation during object or sample positioning, transmitted light illumination for example using a white light emitting diode placed above the Petri dish 82 can be used.

Optionally, standard confocal fluorescence images, image stacks and the FCS data can be acquired on the inverted microscope 6, for example if a confocal laser scanning microscope is used (for example Leica TCS SP5 AOBS SMD FCS equipped with an HCX PlanApo CS 63×/1.2 NA water immersion objective lens). For excitation, the 488 nm line of an Ar laser or another excitation wavelength may be used. The fluorescence can be detected with a photomultiplier tube for imaging and an avalanche photodiode (for example SPCM-AQR-14, Perkin-Elmer Optoelectronics) for imaging and/or FCS. In this particular example, the diameter of the detection pinhole was fixed to the size of 1 Airy disk. The laser power in the sample 8 was well below about 200 μW for FCS and below 500 μW for confocal laser scanning microscopy (CLSM) acquisition as measured in front of the objective lens. For FCS data acquisition, an incident light beam 60 was parked at a position of interest in a previously acquired image, and laser illumination and detector read-out were started for 30-60 s.

FIG. 4A shows the illumination light-sheet imaged with the imaging camera (z axis is viewing direction) and visualized by illuminating in this case Alexa488 dissolved in water. The dashed region highlights the light-pad 10, in this particular example adjusted to a region of 3.8×65 μm² where the light-sheet 22 is thin enough to provide sufficiently small individual observation volume elements (FIG. 1B). In order to characterize the light-sheet thickness, a horizontal mirror can be placed in the centre of the Petri dish 82 filled with water and the Petri dish 82 with the horizontal mirror can be placed in the focal planes of both the illumination objective lens 21 and the detection objective lens 41 to reflect the light-sheet 22 directly into the detection objective lens 41, as shown in FIG. 4B. After removing the dichroic mirror 44 and the emission filter 47 from the first detection light path 40, the focal cross-section of the light-sheet 22 was imaged with the imaging camera 48. The resulting image is shown in FIG. 4C. Fitting a Gaussian function to the averaged horizontal intensity profile yielded a full width at 1/e² of 700±10 nm (FIG. 4D).

The overall PSF was characterized by analyzing image stacks of individual fluorescent beads of 20 nm diameter (see FIG. 4E for the definition of the axes). From fits of 3D Gaussian functions to image stacks of beads (FIG. 4F), a lateral (x-y) 1/e² radius of 370±20 nm and an axial (z) 1/e² radius of 410±40 nm can be used, which means that the PSF is almost isotropic, with an individual observation volume of 0.31 fL. A comparison of lateral and axial intensity profiles extracted from 3D stacks through yeast cells expressing the membrane protein Pma1 fused to GFP (FIG. 4F-4G) confirms the isotropic profile of the PSF.

FIG. 4H-4J show a direct comparison of the same beads characterized using a Leica SP5 confocal microscope equipped with the 1.2 NA water immersion objective and used for confocal FCS. Following the same scheme, a lateral 1/e² radius of 240±10 nm and an axial (z) 1/e² radius of 600±20 nm was obtained, i.e., the PSF is significantly more anisotropic with a volume of 0.19 fL. Taken together, the PSF of the light-pad microscope is isotropic and approx. 1.6-fold larger than the one of a standard confocal microscope and therefore small enough to enable FCS measurements. In addition, the light-pad microscope 1 enables isotropic 3D imaging of samples 8 without the need of imaging the sample from different directions by sample rotation or image deconvolution as compared to conventional light-sheet microscopy.

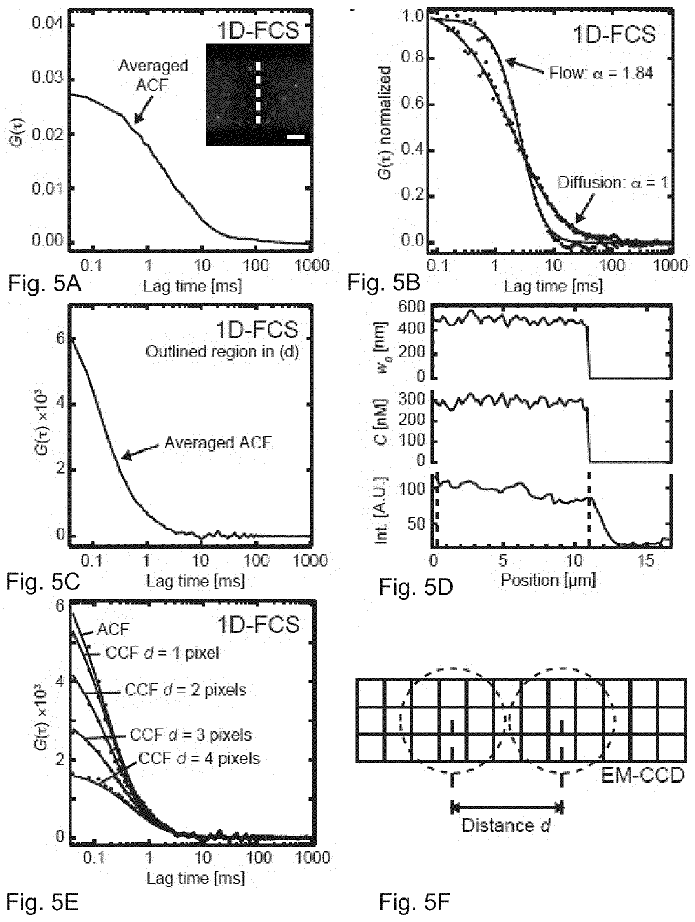

FIGS. 5A-F shows examples of in-vitro 1D/2D-FCS recordings. The light-pad microscope 1 is used for FCS of fluorescent samples in vitro, in this application example. 1D-FCS data of FluoSphere fluorescent beads with a diameter of 20 nm as sample 8 were recorded. FIG. 5A shows 250 individual autocorrelation functions (ACFs) that were calculated from a 1D-FCS recording along the dashed line shown in the insert. The fluorescent beads tended to form heterogeneous aggregates, which were clearly visible in the image raw data (bright dots in the insert shown in FIG. 5A) and which caused a pronounced amplitude and decay heterogeneity of the ACFs. Therefore, the ACFs shown in FIG. 5A were obtained after removing the spikes corresponding to aggregates from the intensity time traces. When performing the 1D-FCS recording close to the surface, at the bottom of the Petri dish 82, a pure Brownian motion of the fluorescent beads was observed whereas in the center of the drop the observable motion was dominated by convective flow. The quality of the aggregate-filtered FCS data allowed us to distinguish the two modes of transport: the ACFs (FIG. 5B) could be fitted with the one-component anomalous diffusion model, (using Eq. (2) defined below), obtaining different anomaly parameters of 1.0 and 1.85, respectively, the former being indicative of pure diffusion and the latter of directional motion as expected from the movements of the large aggregates that can be seen in the movies.

FIG. 5C shows 1D-FCS recordings on a solution of Alexa488 diffusing in distilled water, in order to show the performance of the light-pad microscope 1 and to validate the measured specifications. The 60 individual ACFs are shown in FIG. 5C and recorded from the pixel range marked in FIG. 5D showed only minor variation in amplitude and time dependence. Fitting the ACFs with the one-component free diffusion model, the axial focal radius of 410 nm as determined before and a diffusion coefficient of 320 μm²s⁻¹ as determined independently by cross-correlation analysis (see below and FIG. 5E) allowed the retrieval of an effective lateral focal radius of 490±30 nm (FIG. 5D). For comparison, the inventors calculated the theoretically expected value: since we applied 3-pixel binning to the data (FIG. 5F), the inventors convoluted a rectangular detection profile of 3×190 nm length and a Gaussian function with a 1/e² radius of 370 nm as determined above to obtain an effective detection profile that could be well fitted by a Gaussian function with a 1/e² radius of 500 nm in good agreement with the experimental results. The effective focal volume including binning was 0.57 fL. The molecule numbers obtained from the fit could be transformed into a concentration profile (FIG. 5D) that was virtually constant along the line and allowed to retrieve well the fluorophore concentration used. Thus, 1D-FCS of Alexa488 confirms fully the imaging-based PSF measurements in an independent manner.

In addition to the ACFs calculated, the spatial cross-correlation can be calculated as a function of distance between pixels as shown in FIGS. 5E-5F and by fitting Eq. (2) globally to the CCFs for pixel distances of 0 to 4. A diffusion coefficient of 320±10 μm²s⁻¹ was obtained as an independent fit parameter.

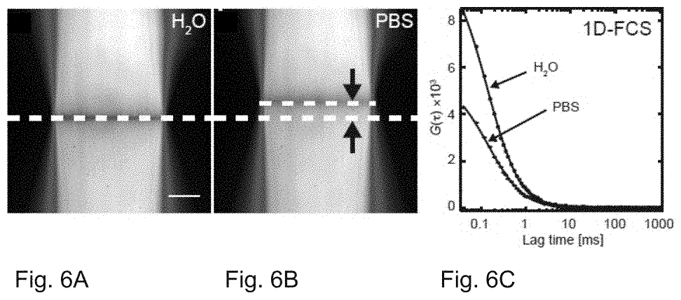

FIGS. 6A to 6C shows the impact of the refractive index of the cell-culturing medium on focussing the light sheet 22. Working in a medium with a refractive index different from that of water, for which the objective lenses are designed, is expected to result in optical aberrations. Considering the long working distance of the objectives 21, 41 that can be used with the light pad microscope 1, even faint differences may exhibit an influence that cannot be ignored. In order to assess this effect on the data obtained from 1D-/2D-FCS recordings with the light-pad microscope 1, we observed the position of the beam waist of the light-sheet 22 using Alexa488 dissolved in water or buffers with different refractive indices (see FIGS. 6A and 6B). Upon illumination with sufficiently high intensity, the waist of the illumination beam could be identified as dark narrow region because of fluorophore saturation close to the illumination focus. This effect could be used to determine precisely the position of the light pad 10. When using Phosphate buffered saline (PBS) instead of water a displacement of the light-pad 10 by 4.5 μm or 0.14% of the working distance towards the illumination objective 21 could be observed (see FIG. 6B). This result demonstrates that the refractive index of the growth medium has to be considered and that the system needs to be adjusted accordingly by proper refocusing and repositioning of the detection objective lens.

FIG. 6C shows 1D-FCS ACFs of Alexa488 at a concentration of 250 nM dissolved in water, 1×PBS, and 1×PBS with Ca²⁺. Fitting the ACFs with a one-component free diffusion model yielded a significant decrease of the amplitudes of 48% for PBS and 64% for PBS/Ca²⁺, when compared to water. In contrast, for the diffusion correlation times only a small relative increase of 9% for PBS and 13% for PBS/Ca²⁺ was observed when compared to water. The differences of the diffusion correlation times could be assigned to the different viscosities of PBS and water (0.99 and 0.89 mPa s at 25° C.); [12, 13]. This indicates that the focal radius was not affected by differences in the refractive index of the medium and that the decreased amplitude resulted from increased out-of-focus signal. To account for the effect of the spherical aberrations on the amplitude, the inventors applied to the concentration values obtained from data fitting a correction factor of 0.52 for in-vivo measurements in PBS and of 0.36 for in-vivo measurements in PBS/Ca²⁺.

### Data Processing and Analysis

An example for data processing and data analysis that may be used with the present disclosure is given below. A person skilled in the art will understand that other data processing or data analysis methods can be used depending on the parameter to be investigated. Known data processing and data analysis method for diffusion of fluorescent molecules (or of fluorescent particles) can be used with the present disclosure.

For each pixel of a 1D- and 2D-FCS measurement, the intensity time trace F_{x,y}(t) from pixel x in line y can be extracted from the image files after subtracting the background signal as acquired in the first 5 s or another part of the full acquisition time and after transforming the pixel gray values into numbers of photoelectrons as described previously. From the resulting fluorescence intensity traces, as well as from the confocal FCS measurements, the autocorrelation functions (ACF) and cross-correlation functions (CCF) can be computed according to

$${G}_{{x}_{1} , {y}_{1} , {x}_{2} , {y}_{2}} ( τ ) = \frac{〈 δ {F}_{{x}_{1} , {y}_{1}} ( t ) δ {F}_{{x}_{2} , {y}_{2}} ( t + τ ) + δ {F}_{{x}_{2} , {y}_{2}} ( t ) δ {F}_{{x}_{1} , {y}_{1}} ( t + τ ) 〉}{2 〈 {F}_{{x}_{1} , {y}_{1}} ( t ) 〉 〈 {F}_{{x}_{2} , {y}_{2}} ( t ) 〉} \\ with \\ δ {F}_{x , y} ( t ) = {F}_{x , y} ( t ) - 〈 {F}_{x , y} ( t ) 〉 and 〈 … 〉 = 1 / T {\int }_{0}^{T} dt … \qquad ( 1 )$$

Slow variations e.g. due to photobleaching can corrected using a sliding average approach. The resulting ACFs and CCFs can be fitted for example with Matlab (The MathWorks) using the non-linear least-squares Levenberg-Marquardt algorithm with the general model function

$${G}_{{x}_{1} , {y}_{1} , {x}_{2} , {y}_{2}} ( τ ) = \frac{1}{N} [ 1 - Θ + Θexp ( - \frac{τ}{{τ}_{blink}} ) ] {\sum }_{i = 1}^{2} {{{f}_{i} [ 1 + {( \frac{τ}{{τ}_{diff , i}} )}^{{α}_{i}} ]}^{- 1} [ 1 + \frac{{w}_{0}^{2}}{{z}_{0}^{2}} {( \frac{τ}{{τ}_{diff , i}} )}^{{α}_{i}} ]}^{- 1 / 2} \times exp \{ - {\frac{{( {x}_{2} - {x}_{1} )}^{2} {δ}^{2} + {( {y}_{2} - {y}_{1} )}^{2} {δ}^{2}}{{w}_{0}^{2}} [ 1 + {( \frac{τ}{{τ}_{diff , i}} )}^{{α}_{i}} ]}^{- 1} \} \qquad ( 2 )$$

in which N is the (apparent) number of molecules and which accounts for molecular blinking with the fraction Θ of molecules in a non-fluorescent state of lifetime τ_{blink} and considering anomalous diffusion of two components f₁, f₂=1−f₁ with the diffusion correlation times τ_{diff,i}=w₀²/(4Dᵢ), the lateral and the axial focal radii w₀, z₀, the apparent diffusion coefficients D as well as the anomaly parameters a, of components i=1,2. In the case of CCFs, the pixel displacement is taken into consideration with the second exponential term including the pixel size 6 and the pixel indices x₁, y₁, x₂, y₂, whereas for ACFs, that term is one. For 1D- and 2D-FCS data of fluorescent beads and Alexa488, curve fitting can be done without any blinking contribution, i.e., Θ=0. For confocal and 1D-FCS data of green fluorescent proteins, the non-fluorescent lifetime can be assumed to be 100 μs. For 2D-FCS data, a time resolution of 0.7 ms allows to neglect the blinking contribution, i.e., Θ=0. For single component fits, f₁=1 is set. The goodness of the fit can be assessed by means of the R-square (R_{adj}²) adjusted to the degrees of freedom with 0≤R_{adj}²≤1. It can be useful to accepted fits with R_{adj}²≥0.8 or higher.

In this way, profiles (1D-FCS) and maps (2D-FCS) of the fit parameters, of the goodness of fit R_{adj}² and of the pixel intensity can be created. By thresholding the intensity and/or R_{adj}² maps, binary masks can be generated in order to exclude noisy data and/or unsatisfactory fits and to pick those regions, for which the finally resulting concentrations, diffusion coefficients and fractions of components are mapped.

### Example 1

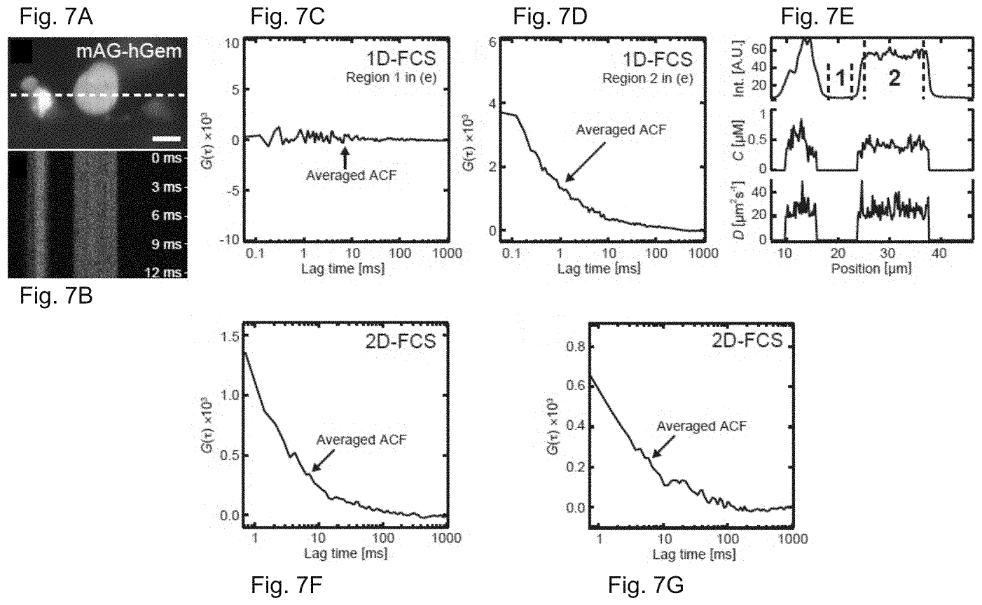

FCS measurements inside living objects or samples, such as cells, are particularly challenging because of the heterogeneous interior of the cells and the limited number of fluorescent-labelled molecules. We investigated the usability of FCS imaging in vivo by measuring the diffusion of an endogeneously expressed green fluorescent protein-tagged protein, the 40 kDa mAG-hGem(1/110) component of the cell cycle reporter system Fucci [14, 15] in MDCK cells in S/G2 phase of the cell cycle (FIG. 7A). FCS recordings with one line of the EM-CCD (1D-FCS, FIG. 7B) allowed to calculate autocorrelation functions (ACFs) that featured a diffusion-induced decay in the area of the nucleus, where the mAG-hGem protein localizes (FIG. 7C). In contrast, non-correlating ACFs were obtained from cytoplasmic areas and the intracellular space (FIG. 7D). Fitting the ACFs with a one-component anomalous diffusion model function (as explained above) yielded an average apparent diffusion coefficient of 25±7 μm²s⁻¹ and a concentration of the protein for this specific cell of 420±120 nM (FIG. 7E). The confocal FCS measurements performed using other cells from the same cell line validated the diffusion coefficient (20±3 μm²s⁻¹; FIGS. 6A-6B). 2D-FCS recordings of a 15×102 pixel area corresponding to ˜3×19 μm² across a cell nucleus revealed a rather homogenous distribution of diffusion coefficients and concentrations, as expected, with very similar average values (FIG. 7F) for this and other cells studied. We noticed that the slower acquisition speed associated with 2D-FCS recordings affected mostly the precision of estimating properly the concentration. When comparing a time resolution of 1 μs to 40, 700 or 1400 μs, the confidence interval from the fit increased 1.5-, 3- or 5-fold, in case of a diffusion correlation time of 3 ms (as typically observed for GFP). In contrast, the estimation of the diffusion coefficient remained almost unaffected. These data validate that 1D- and 2D-FCS recordings enable the retrieval of diffusion coefficients from living cells with good accuracy. Measurements of protein concentrations are less reliable when using 2D-FCS recordings, however, this information can be approximated from the signal intensity, and it is a less relevant parameter in all the cases where transient transfection systems are used due to cell-to-cell variations in the expression of the protein. The accuracy of protein concentration measurements can be improved by a better time sampling of the 2D-FCS acquisition using next generations of detector arrays (for instance sCMOS camera).

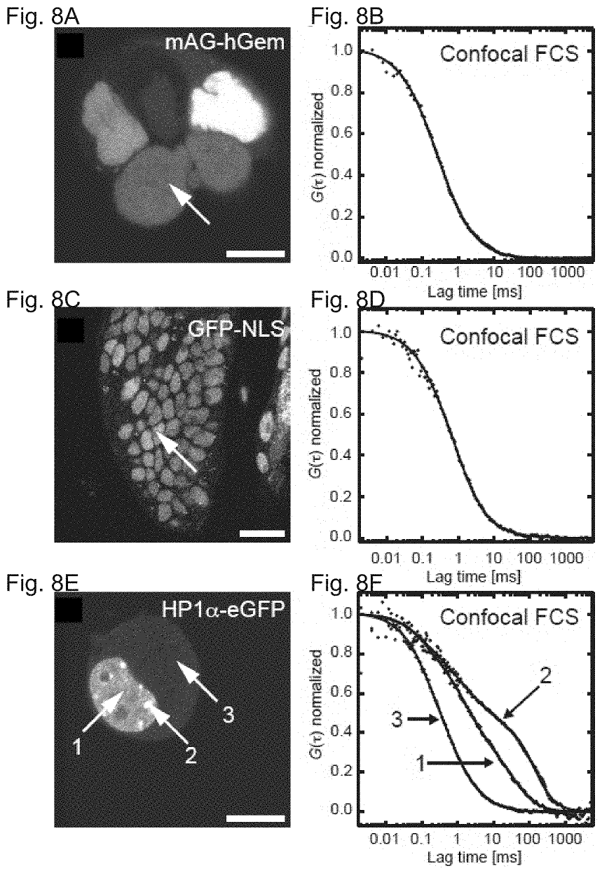

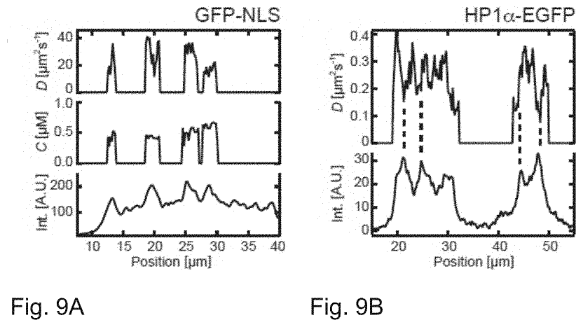

To investigate whether it is possible to use the light-pad microscope to study protein diffusion in cells in entire tissues, we investigated the diffusion of NLS-GFP (GFP fused to a nuclear localisation signal, NLS) in wing imaginal disks of Drosophila larvae. A 3D reconstruction of a large area of the tissue generated by scanning it horizontally through the light-pad, revealed (sub-) cellular structures up to a depth of ˜50 μm. FCS imaging performed in a selected area of a freshly prepared wing disk provided the diffusion coefficient of NLS-GFP inside the nuclei (FIG. 7G, FIG. 9A), amounting to an average of 19±6 μm²s⁻¹. The value was consistent with measurements performed using confocal FCS (14±2 μm²s⁻¹, FIGS. 8C-8D). This demonstrates that the light-pad microscope can be used to study the diffusion of fluorescently labelled proteins inside embryonic tissues.

### Example 2

Members of the heterochromatin protein 1 (HP1) family undergo dynamic interactions with DNA and with specifically modified chromatin-binding and -forming proteins, in particular Lys9-di- or tri-methylated nucleosomal histone H3 as well as a broad range of factors involved in genome homeostasis, thus playing complex functions in heterochromatin establishment and maintenance, euchromatin organization, transcriptional repression, DNA replication and DNA damage repair. The dynamics of HP1 interactions with DNA were measured previously by photobleaching and confocal FCS demonstrating that heterochromatin is accessible to regulatory factors and that HP1α enrichment in heterochromatin is due to an increased but still very dynamic interaction of the protein with chromatin, in particular with methylated nucleosomal histone H3. Local measurements by confocal FRAP (fluorescence relaxation after photobleaching) or FCS were guided by the brightness of the HP1α staining, which is strong in heterochromatin, and were limited to a few measurements per cell. Therefore, such investigations did not reveal whether the rather uniform intensity of the euchromatin staining of HP1α, which comprises the larger fraction of the nuclear volume, is associated with a uniform mobility. Here, a 1D-FCS recording (FIG. 9B) in murine 3T3 cells expressing full length HP1α revealed areas with a fast and a slowly diffusing component of HP1α mobility. The measured values of the slow component (between 0.07 μm²s⁻¹ and 0.41 μm²s⁻¹, consistent with confocal FCS data, FIGS. 8E-8F) exhibited a partial anticorrelation to the fluorescence intensity distribution (FIG. 9b). However, the spatial resolution and dimensionality of the 1D-FCS recordings was not sufficient to clearly distinguish eu- and heterochromatin.

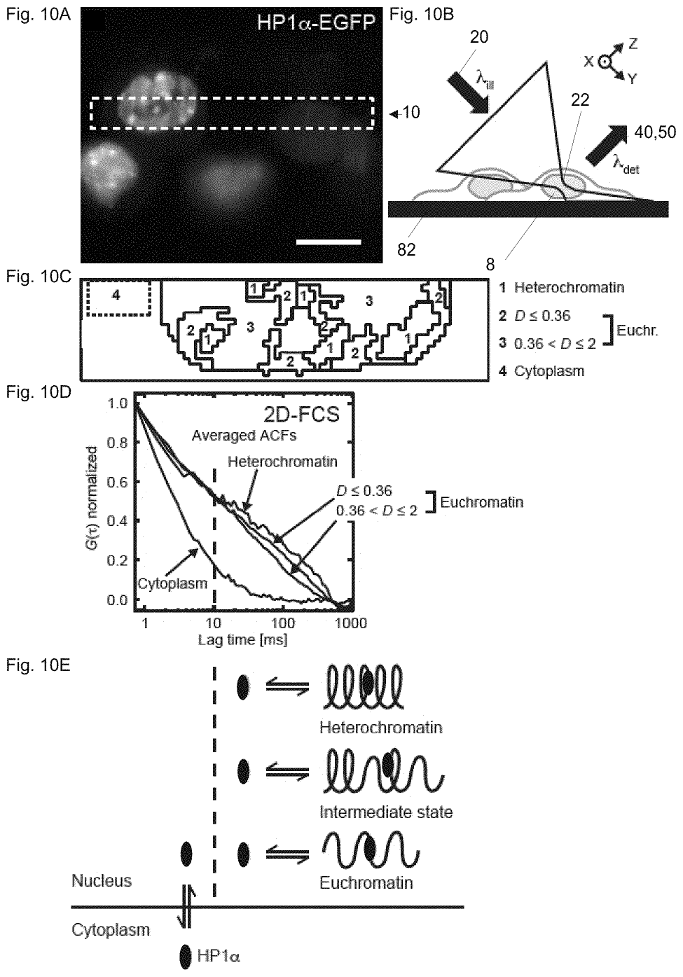

FIGS. 10A to 10E shows spatially resolved analysis of HP1α mobility in 3T3 cells by FCS imaging. FIG. 10A is an overview of 3T3 cells expressing HP1α-EGFP. The dashed rectangle indicates the light-pad 10 area and the scale bar corresponds to 10 μm. FIG. 10B is schematic illustration of the illumination and observation of cells as samples 8 in a Petri dish 82. The high aperture angle of the illumination light-sheet 22 (74°) leads to weak illumination of cells lying outside the light-pad 10 area. Optical sectioning is performed under 45° with respect to the bottom of the Petri dish 82. Segmentation based on intensity thresholds was used to delimitate eu- and heterochromatin areas as well as the cytoplasm. Additional segmentation based on a diffusion coefficient threshold at D=0.36 μm²s⁻¹ (mean value plus one standard deviation of the distribution of diffusion coefficients in heterochromatin) was applied to FIG. 8E to identify regions in euchromatin differing in the mean apparent diffusion coefficient of HP1α. The scale bar corresponds to 1 μm. FIG. 10D shows ACFs calculated and averaged for the four different regions highlighted in the segmentation map of FIG. 10C. FIG. 10E shows a schematic model of HP1α mobility resulting from diffusion and chromatin binding in 3T3 cells. A first fraction is diffusing freely (fast component in the ACFs) in cytoplasm and nucleus. A slow chromatin-interacting fraction is only found in the nucleus (slow component in the ACFs) with a slower apparent diffusion coefficient in heterochromatin than in euchromatin, resulting from a higher affinity to chromatin in hetero-compared to euchromatin. However, in some parts of the euchromatin the HP1α mobility (and thus the chromatin affinity) is similar to heterochromatin. This corroborates the emerging role of HP1α as an important factor in euchromatin related processes.

The spatially better resolved investigation of the HP1α mobility using 2D-FCS recording revealed a diffusion coefficient of 10-40 μm²s⁻¹ in the cytoplasm. In the nucleus, a two-component fit yielded for the slow fraction 0.29±0.07 μm²s⁻¹ in high-intensity heterochromatin and a broad distribution of 0.48±0.25 μm²s⁻¹ in the low-intensity euchromatin areas. The inventors subdivided the euchromatin into regions with apparent diffusion coefficients below and above a threshold of 0.36 μm²s⁻¹ (the mean value plus one standard deviation of the distribution in heterochromatin). This analysis indicated bona fide euchromatin regions with an HP1α mobility of 0.29±0.05 μm²s⁻¹ that corresponded very well to the one observed in heterochromatin regions (see above). However, the relative amount of chromatin-bound HP1α was smaller, as indicated by the lower amplitude of the curve. The remaining euchromatin exhibited a higher diffusion coefficient of 0.61±0.26 μm²s⁻¹ (FIGS. 10C-10D). This demonstrates that FCS imaging has the potential to provide new insights into the spatial organization of cellular structures and how protein abundance and mobility correlate with each other.

3T3 cells stably expressing HP1α-EGFP were cultivated as known in the art. For confocal imaging and FCS measurements, cells were grown in 8-well chambered cover glasses and the medium was replaced by phenol red-free medium before the experiments. For light-pad imaging and 1D-/2D-FCS measurements, cells were grown on pieces of 1 mm thick cover slide glass smaller than 4×10 mm², which were transferred to Petri dishes containing 1×PBS before the experiments.

### Final Remarks

It should be understood that the above examples are purely illustrative and show examples how the light-pad microscope can be used or tested. The application as defined by the claims is not limited to a specific example or application. Many other applications of the light-pad microscope are possible and a person skilled in the art will find many different biological and non-biological samples that can be investigated with the light-pad microscope. Other method for data evaluation may also be used with the light-pad microscope.

### REFERENCES

1. E. L. Elson, and D. Magde, “Fluorescence correlation spectroscopy. I Conceptual basis and theory,” Biopolymers 13, 1-27 (1974).
2. S. A. Kim, K. G. Heinze, and P. Schwille, “Fluorescence correlation spectroscopy in living cells,” Nature Methods 4, 963-973 (2007).
3. Handbook of Biological Confocal Microscopy (Springer, Heidelberg, 2006).
4. C. I. Maeder, M. A. Hink, A. Kinkhabwala, R. Mayr, P. I. Bastiaens, and M. Knop, “Spatial regulation of Fus3 MAP kinase activity through a reaction-diffusion mechanism in yeast pheromone signalling,” Nature Cell Biology 9, 1319-1326 (2007).
5. B. D. Slaughter, J. W. Schwartz, and R. Li, “Mapping dynamic protein interactions in MAP kinase signaling using live-cell fluorescence fluctuation spectroscopy and imaging,” Proceedings of the National Academy of Sciences of the USA 104, 20320-20325 (2007).
6. U. Schmidt, K. B. Im, C. Benzing, S. Janjetovic, K. Rippe, P. Lichter, and M. Wachsmuth, “Assembly and mobility of exon-exon junction complexes in living cells,” RNA 15, 862-876 (2009).
7. M. Huranova, I. Ivani, A. Benda, I. Poser, Y. Brody, M. Hof, Y. Shav-Tal, K. M. Neugebauer, and D. Stanek, “The differential interaction of snRNPs with pre-mRNA reveals splicing kinetics in living cells,” Journal of Cell Biology 191, 75-86 (2010).
8. S. R. Yu, M. Burkhardt, M. Nowak, J. Ries, Z. Petrasek, S. Scholpp, P. Schwille, and M. Brand, “Fgf8 morphogen gradient forms by a source-sink mechanism with freely diffusing molecules,” Nature 461, 533-U100 (2009).
9. E. H. K. Stelzer, “Light sheet based fluorescence microscopes (LSFM, SPIM, DSLM) reduce phototoxic effects by several orders of magnitude,” Mechanism of Development 126, S36-S36 (2009).
10. M. Wachsmuth, W. Waldeck, and J. Langowski, “Anomalous diffusion of fluorescent probes inside living cell nuclei investigated by spatially-resolved fluorescence correlation spectroscopy,” Journal of Molecular Biology 298, 677-689 (2000).
11. M. Weiss, “Probing the interior of living cells with fluorescence correlation spectroscopy,” Annals of the New York Academy of Science 1130, 21-27 (2008).
12. CRC Handbook of Chemistry and Physics (CRC Press, Boca Raton, 2008).
13. K. Luby-Phelps, S. Mujumdar, R. B. Mujumdar, L. A. Ernst, W. Galbraith, and A. S. Waggoner, “A novel fluorescence ratiometric method confirms the low solvent viscosity of the cytoplasm,” Biophysical Journal 65, 236-242 (1993).
14. A. Sakaue-Sawano, H. Kurokawa, T. Morimura, A. Hanyu, H. Hama, H. Osawa, S. Kashiwagi, K. Fukami, T. Miyata, H. Miyoshi, T. Imamura, M. Ogawa, H. Masai, and A. Miyawaki, “Visualizing spatiotemporal dynamics of multicellular cell-cycle progression,” Cell 132, 487-498 (2008).
15. M. Sugiyama, A. Sakaue-Sawano, T. Iimura, K. Fukami, T. Kitaguchi, K. Kawakami, H. Okamoto, S. Higashijima, and A. Miyawaki, “Illuminating cell-cycle progression in the developing zebrafish embryo,” Proceedings of the National Academy of Sciences of the USA 106, 20812-20817 (2009).

What is claimed is:

1. A microscope having an illumination light path for illuminating a sample through an illumination objective lens and at least one viewing light path for viewing the sample through a detection objective lens, the microscope comprising
an illumination light path focusing arrangement in the illumination light path, the illumination light path focusing arrangement comprising a scanning module for generating a substantially two-dimensional object illumination region extending along an illumination direction of the illumination light path and a direction transverse thereto; and
an illumination region-confining device in the illumination light path for selectively illuminating a portion of the substantially two-dimensional object illumination region, wherein the portion of the substantially two-dimensional object illumination region is confined at least in one of the illumination direction and the direction transverse thereto.

2. The microscope of claim 1, wherein the scanning module comprises at least one of a rotatable plane scanning mirror, a translatable scan lens, a translatable lens array, or a translatable curved mirror.

3. The microscope of claim 1, wherein the illumination light path focusing arrangement comprises an additional scanning module for at least one of positioning the object illumination region at the sample or scanning the object illumination region across the sample.

4. The microscope of claim 1, wherein the illumination region-confining device comprises at least a first aperture for confining the portion of the substantially two-dimensional object illumination region in the illumination direction.

5. The microscope of claim 1, wherein the illumination region confining device comprises at least a second aperture for confining the portion of the substantially two-dimensional object illumination region in a direction transversely to the illumination direction.

6. The microscope of claim 1, wherein the illumination region-confining devices comprises a light beam shaper.

7. The microscope of claim 1, wherein a viewing direction of the at least one viewing light path is substantially perpendicular to the illumination direction and to the substantially two-dimensional object illumination region.

8. The microscope of claim 1, further comprising an adjustable detection aperture in a detection path that allows reducing an effectively viewed region in one or two dimensions.

9. The microscope of claim 8, wherein the portion of substantially two-dimensional object illumination region and the effectively viewed region are congruent and/or coincident.

10. The microscope of claim 9, wherein the portion of substantially two-dimensional object illumination region and the effectively viewed region are at least one of congruently or coincidently moveable through the sample.

11. The microscope of claim 1, further comprising an additional objective lens for at least one of illumination or viewing of the sample arranged in the substantially two-dimensional object illumination region.

12. The microscope of claim 11, wherein the microscope comprises further an epi-illumination and epi-detection microscope and the additional objective lens is part of the epi-illumination and epi-detection microscope.

13. The microscope of claim 11, wherein the microscope comprises further an inverted microscope and the additional objective lens is part of an inverted microscope.

14. A method for detecting a sample, the method comprising:
illuminating, through an illumination objective lens, a two-dimensional portion of a sample by scanning and focusing an illumination light beam into a substantially two-dimensional object illumination region extending in an illumination direction of the illumination light beam and a direction transverse thereto;
wherein illuminating the two-dimensional portion further comprises confining the substantially two-dimensional object illumination region for selectively illuminating a portion of the substantially two-dimensional object illumination region, wherein the portion of the substantially two-dimensional object illumination region is confined at least in the illumination direction.

15. The method of claim 14, wherein the scanning of the illumination light beam comprises at least one of reflecting the illumination light beam from a rotatable plane scanning mirror, passing the illumination light beam through a translatable scan lens, passing the illumination light beam through a translatable lens array, or reflecting the illumination light beam from a translatable curved mirror.

16. The method of claim 14, further comprising moving the two-dimensional object illumination region across the sample for at least one of positioning the two-dimensional object illumination region at the sample or scanning the two-dimensional illumination region across the sample.

17. The method of claim 14, further comprising viewing the substantially two-dimensional object illumination region in a viewing direction, the viewing direction being substantially perpendicular to the illumination direction.

18. The method of claim 14, further comprising measuring a signal fluctuation in the portion of the substantially two-dimensional object illumination region.

19. The method of claim 14, further comprising measuring a fluorescence intensity contrast for alignment.

20. The method of claim 14, further comprising at least one of illuminating or viewing the sample through an additional objective lens.
